(19) United States
(12) Patent Application Publication
(10) Pub. No.: US 2009/0200701 A1
(43) Pub. Date: Aug. 13, 2009

(54) MAKING SERVING PLATTER HAVING DISPOSAL OPENING AND SHALLOW SEALING LID

(76) Inventors: Ian D. Kovacevich, Charlotte, NC (US); Daniel Lee Bizzell, Davidson, NC (US)

Correspondence Address: TILLMAN WRIGHT, PLLC, P.O. BOX 473909, CHARLOTTE, NC, 28247, US

(21) Appl. No.: 12/028,827

(22) Filed: Feb. 10, 2008

(51) Int. Cl. B29C 70/00

(52) U.S. Cl. 264/250

(57) ABSTRACT

A method of making a serving platter includes molding a hand portable main body such that the main body includes rectangular, single molded piece having a top portion defining a serving area and a bottom portion. The top portion includes four primary serving wells and four secondary serving wells. The bottom portion defines an enclosed interior space, and the top portion defines a rounded opening that is configured to receive food waste into the interior space. The top portion includes four dividing walls defining and separating the four primary serving wells, each dividing wall extending generally linearly away from the rounded opening to an outer peripheral wall of the main body. The top portion further includes four partitioning walls, each partitioning wall extending between adjacent sides of the outer peripheral wall. Each serving well has a volume that is less than half of the volume of each primary serving well.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

Trays for snacks and appetizer-type foods are generally known. Such trays provide a place to display these foods for presentation and for eating. They also generally make it easier to transport these foods. Unfortunately, many trays do not have seating lids that enable them to serve as food containers during transport from one location to another, e.g., from a restaurant to a home. Therefore, when foods that are traditionally presented on a tray are transported from one location to another, a container other than the tray is generally used during transport.

Another problem that exists, particularly for foods such as chicken wings that create their own waste, is finding a place to put the waste prior to its being thrown away. In most cases, a trash receptacle is not located within easy reach of a table or other dining area, typically because it is unsanitary or unsightly. As such, a diner is faced with the problem of having a place to put the waste while the food creating the waste is being eaten. Generally, such waste is unappetizing and an eater would prefer to have the waste out of sight while continuing to eat.

Anderson et at. U.S. patent application Ser. No. 11/870,538, which published as U.S. Patent Application Publication No. 2008/0029427, both of which patent references are incorporated herein by reference, address one or more of the foregoing problems. Similarly, SHEW et al. U.S. patent application Ser. No. 12/028,810, which published as U.S. patent application Publication Ser. No. ______, both of which patent references are incorporated herein by reference, address one or more of the foregoing problems. While the solutions presented therein may be suitable for their intended purposes, needs exists for alternative solutions to one or more of the foregoing problems. One or more preferred embodiments of the present invention provide such an alternative.

### SUMMARY OF THE INVENTION

The present invention includes many aspects and features.

In a first aspect of the invention, a serving platter includes a main body. The main body includes a top portion defining a serving area comprising a plurality of primary serving wells for receiving food items therein for presentation to a person for eating; and a bottom portion defining a substantially enclosed interior space. The top portion further defines a disposal opening configured to receive there through food waste for deposit into the substantially enclosed interior space. In accordance with this aspect, the top portion includes a plurality of dividing walls defining and separating the primary serving wells; and the top portion further defines a plurality of secondary serving wells, each secondary serving well being defined by a partitioning wall that extends between adjacent sides of the outer peripheral wall of the main body.

In features of this aspect, the top portion and the bottom portion are part of a single molded piece; each of the primary serving wells shares in common a dividing wall with another primary serving well; each secondary serving well includes a volume that is less than half of the volume of each primary serving well; the disposal opening comprises a circular opening centrally located relative to the serving area; each dividing wall extends generally linearly away from the circular opening; each dividing wall extends from the circular opening to the outer peripheral wall of the main body; the main body is generally rectangular; the serving platter consists of four primary serving wells; the serving platter consists of four equally dimensioned primary serving wells symmetrically arranged about the disposal opening of the serving area; and/or each primary serving well has a bottom defining a food support surface, and wherein the food support surface is planar and configured to be generally horizontal when the serving platter is placed on a generally horizontal surface.

In another feature, the serving platter further includes a lid removably that is coupled to the main body such that the lid is positioned above and extends over the serving area during transport of the serving platter, the lid defining a plurality of dividers, wherein each of the dividing walls is generally aligned with and engaged by a respective divider such that two wells are isolated from one another by a dividing wall engaged with a divider, and wherein each of the partitioning walls is generally aligned with and engaged by a respective divider such that a primary serving well and a secondary serving well are isolated from one another by a partitioning wall engaged with a divider. In connection with this feature, a dividing wall is engaged by a divider by being received within a channel or recess that is defined by the lid.

In another aspect, a serving platter includes a generally rectangular, single molded piece. The main body includes a top portion defining a serving area comprising a plurality of primary serving wells for receiving food items therein for presentation to a person for eating; and a bottom portion defining a substantially enclosed interior space, the top portion defining a rounded opening centrally located relative to the serving area and configured to receive there through food waste for deposit into the substantially enclosed interior space. In accordance with this aspect, the top portion includes a plurality of dividing walls defining and separating the primary serving wells, each dividing wall extends generally linearly away from the rounded opening to an outer peripheral wall of the main body, each of the primary serving wells sharing in common a dividing wall with another primary serving well; and the top portion further defines a plurality of secondary serving wells, each secondary serving well being defined by a partitioning wall that extends between adjacent sides of the outer peripheral wall of the main body, each secondary serving well having a volume that is less than half of the volume of each primary serving well.

In a feature of this aspect, the serving platter further includes a lid removably coupled to the main body such that the lid is positioned above and extends over the serving area and seats off the central opening of the top portion. The lid further preferably defines a plurality of dividers, each of the dividing walls being generally aligned with and engaged by a respective divider such that two wells are seated off from one another by a dividing wall engaged with a divider. Each of the partitioning walls also preferably is generally aligned with and engaged by a respective divider such that a primary serving well and a secondary serving well are isolated from one another by a partitioning wall engaged with a divider.

In still another aspect of the invention, a serving platter includes a generally rectangular, single molded piece. The main body includes top portion defining a serving area and a bottom portion. The top portion includes four primary serving wells for receiving food items therein for presentation to a person for eating, and four secondary serving wells. The bottom portion defines a substantially enclosed interior space, the top portion defining a rounded opening centrally located relative to the serving area and configured to receive there through food waste for deposit into the substantially enclosed interior space. In accordance with this aspect, the top portion includes four dividing walls defining and separating the four primary serving wells, each dividing wall extending generally linearly away from the rounded opening to an outer peripheral wall of the main body, each of the four primary serving wells sharing in common a dividing wall with another of the four primary serving wells; and the top portion further includes four partitioning walls, each partitioning wall extending between adjacent sides of the outer peripheral wall of the main body, each serving well having a volume that is less than half of the volume of each primary serving well.

In a feature of this aspect, the serving platter further includes a lid that is configured to be removably coupled to the main body such that the lid is positioned above and extends over the serving area and seats off the central opening of the top portion. Moreover, the lid preferably defines a plurality of dividers, each of the dividing walls being generally aligned with and engaged by a respective divider such that two wells are seated off from one another by a dividing wall engaged with a divider; and each of the partitioning walls also preferably is generally aligned with and engaged by a respective divider such that a primary serving well and a secondary serving well are isolated from one another by a partitioning wall engaged with a divider.

Additional aspects of the invention include methods of making and using serving platters in accordance with the foregoing aspects.

In addition to the aforementioned aspects and features of the present invention, it should be noted that the present invention further encompasses the various possible combinations of such aspects and features.

### BRIEF DESCRIPTION OF THE DRAWINGS

One or more preferred embodiments of the present invention now will be described in detail with reference to the accompanying drawings, wherein:

FIG. 1 is a perspective view of a serving platter in accordance with a preferred embodiment of the present invention.

FIG. 2 is a perspective view of the serving platter of FIG. 1, wherein a lid thereof has been decoupled and separated from a main body of the serving platter, thereby uncovering a serving area.

FIGS. 3-5 are various perspective views of the main body of the serving platter of FIG. 1.

FIG. 6 is an enlarged perspective view of the main body of the serving platter of FIG. 1.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its applications, or uses.

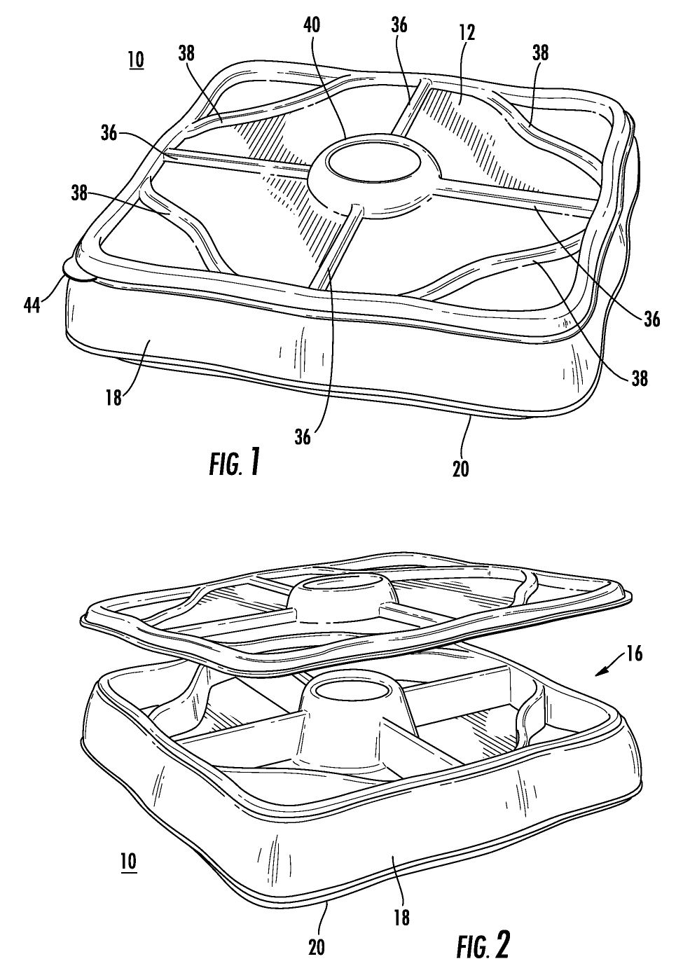

Turning now to the drawings, a serving platter 10 in accordance with a preferred embodiment of the present invention is shown in FIGS. 1 and FIG. 2. In FIG. 1, a shallow lid 12 and main body 14 of the serving platter are removably coupled together. In contrast, the lid 12 is shown decoupled and separated from the main body 14 in FIG. 2, thereby uncovering a serving area 16 of the serving platter. The lid 12 is removably coupled to the main body 14 in a frictional fit such that the lid 12 is positioned above and extends over the serving area 16 and seats off the serving area 16. Food items disposed on the serving platter 10 are thereby covered and protected from the environment and from being spitted during transport and/or storage of the serving platter 10. Although not illustrated, the frictional fit may be enhanced by grooves, recesses, indentations, ridges and the like. Moreover, a separation tab 44 further is incorporated on the lid 12 to aid in uncovering the main body 14 of the serving platter 10.

In at least one preferred commercial embodiment, the lid 12 is at least partially fabricated of a translucent or transparent material so that food items carried on the serving platter 10 may be at least partially viewed through the lid during transport. Alternatively, the lid 12 is neither translucent nor transparent.

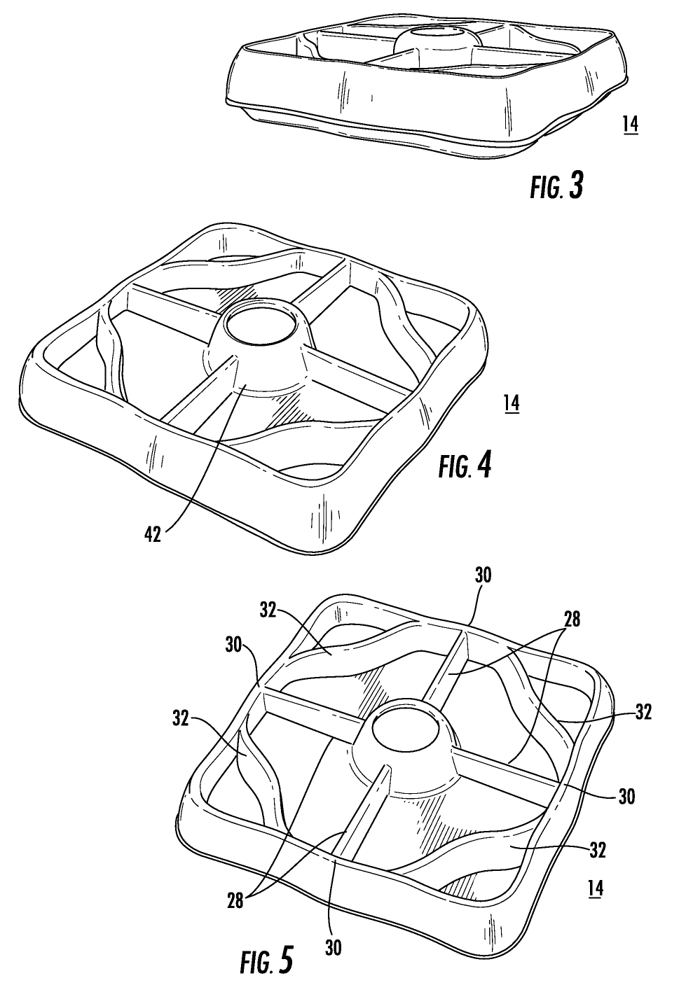

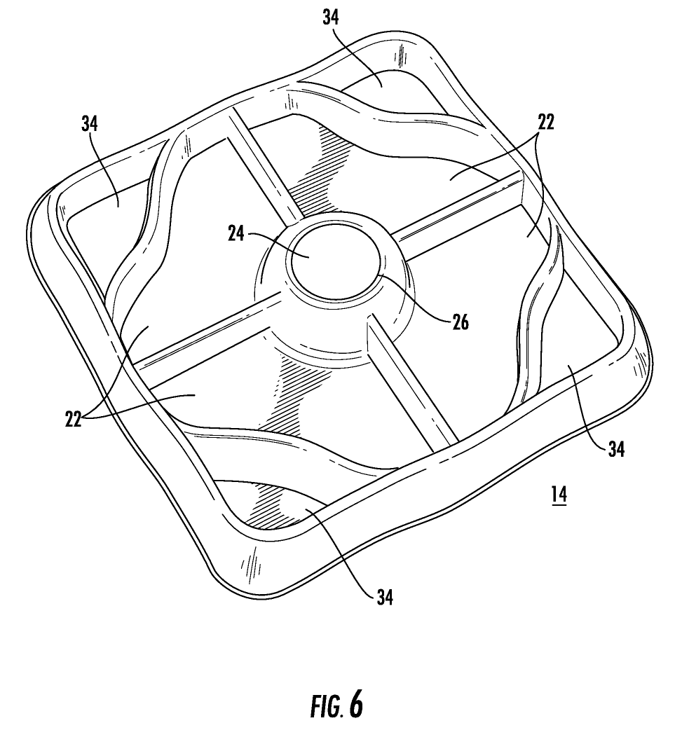

The main body 14 of the serving platter additionally is shown from different perspective views in FIGS. 3-5. FIG. 6 is an enlarged perspective view of the main body 14 of the serving platter.

The main body 14 is generally rectangular and preferably comprises of a top portion 18 and a bottom portion 20 that together constitute a single molded piece. The top portion 18 defines the serving area 16, which includes a plurality of primary serving wells 22 for receiving food items therein for presentation to a person for eating. The bottom portion 20 defines a substantially enclosed interior space 24.

The top portion 18 includes a generally circular rim 26 that defines a disposal opening configured to receive there through food waste for deposit into the substantially enclosed interior space 24. The generally circular rim 26 defining the disposal opening is centrally located relative to the serving area 16.

The top portion 18 includes a plurality of dividing walls 28 defining and separating the primary serving wells 22 such that each primary serving well 22 shares a dividing wall 28 in common with another primary serving well 22. Each dividing wall 28 extends from the circular opening generally linearly away from the circular opening to an outermost peripheral wall 30 of the main body 14.

A plurality of partitioning walls 32 defines a plurality of secondary serving wells 34. Each secondary serving well 34 is defined by a partitioning wall 32 that extends between adjacent sides of the outermost peripheral wall 30 of the main body 14, whereby each secondary serving well 34 is located at a corner of the serving platter 10. Each secondary serving well 34 preferably is smaller than each primary serving well 22, and each secondary serving well 34 may include a volume that is less than half of the volume of each primary serving well 22.

Each of the dividing walls 28 is engaged by the lid 12 such that two serving wells 22 are isolated from one another by a dividing wall 28 engaged with the lid 12. In particular, the lid 12 defines a plurality of dividers 36, each of the dividing walls 28 of the main body 14 is generally aligned with a respective divider 36 when the lid 12 is removably coupled to the main body 14, and each dividing wall 28 is engaged by the corresponding divider 36 such that two primary serving wells 22 are isolated from one another by their common dividing wall 28 and the lid 12. Each divider 36 preferably comprises a channel or recess defined by the lid 12, and each dividing wall 28 is engaged by being frictionally received by a divider 36 (i.e., within a recess or channel defined by the lid 12).

Moreover, the lid 12 preferably defines a plurality of additional dividers 38 for which each of the partitioning walls 32 is generally aligned when the lid 12 is removably coupled to the main body 14. In this respect, each partitioning wall 32 is engaged by the corresponding divider 38 such that a primary serving well 22 and a secondary serving well 34 are isolated from one another by the partitioning wall 32 and the corresponding divider 38 with which the partitioning wall 32 is engaged. Each divider 38 that engages a partitioning wall 32 also comprises a channel or recess defined by the lid 12, and each partitioning wall 32 is engaged by being frictionally received within such recess or channel.

The serving platter 10 as shown consists of four equally dimensioned primary serving wells 22 that are symmetrically arranged about the disposal opening of the serving area 16. Furthermore, each primary serving well 22 has a bottom defining a food support surface, and the food support surface is generally planar and is configured to be generally horizontal in orientation when the serving platter 10 is placed on a generally horizontal surface, such as a tabletop or countertop.

The lid 12 also includes a generally circular divider 40 which engages the rim 26 of the top portion when the lid 12 is removably coupled to the main body 14, whereby the disposal opening is seated off from the primary serving wells 22 as well as from the exterior of the serving platter 10 by the lid 12.

The serving platter 10 may be used to serve, store, and transport food items, particularly appetizer-type food items that create their own waste, naturally or otherwise. An example of such a food item is chicken wings. Additional food items may include tail-on shrimp, ribs, or food items for which toothpicks are to be utilized as an assembly toot or utensil, such as meatballs. It is contemplated that different primary serving wells 22 may hold differing kinds of food items, e.g., two wells 22 may hold chicken wings, one well 22 may hold celery, and another well 22 may hold carrots. It is also contemplated that different wells 22 may hold similar food items that have been prepared differently or prepared with different kinds of sauces, e.g., one well 22 may hold chicken wings prepared with mild sauce, one well 22 may hold chicken wings prepared with medium sauce, one well 22 may hold chicken wings prepared with hot sauce, and another well 22 may hold chicken wings prepared with no sauce. In any event, it is preferred that each primary serving well 22 be capable of receiving therein a plurality of a particular food item, such as ten chicken wings, in such a way as to prevent food in one primary serving well 22 from inadvertently spilling over and coming into contact with food in another primary serving well 22 as well as in a secondary serving well 34.

The secondary wells 34 preferably hold sauces or dips that go with the food items contained within the respective primary serving wells 22. Alternatively, the secondary serving wells 34 may also hold similar food items as the primary serving wells 22, but just in less quantity.

Each of the primary serving wells 22 is approximately as deep as the height of the outermost peripheral wall 30, and the well-dividing walls 28 are approximately the same height as the outermost peripheral wall 30. In at least some embodiments, the top of an innermost conical wall 42 that includes the rim 26 defining the disposal opening is commensurate with the top of the dividing walls 28 and with the top of the outermost peripheral wall 30. In other embodiments, the top of the dividing walls 28 is commensurate with the top of the outermost peripheral wall 30 of the serving platter 10, but the top of the innermost conical wall 42 extends slightly above the top of the dividing walls 28 and the top of the outermost peripheral wall 30.

Because the dividing walls 28, partitioning walls 32, and innermost conical wall 42 (i.e., rim 26) each engages the lid 12, the lid 12 provides a stabilizing structure for the serving platter 10 when the lid 12 is removably coupled to the main body 14. Moreover, it is believed that slight extension of the innermost conical wall 42 above the outermost peripheral wall 30 and the top of the dividing walls 28 and partitioning walls 32 increases the stability that is provided when the lid 12 is removably coupled to the main body 14.

In use, the serving area 16 of the serving platter 10 is loaded with the desired food items, e.g., chicken wings, typically in a kitchen or other food preparation area of a restaurant or the like, by placing the food items in the primary serving wells 22 thereof. The lid 12 is then secured to the main body 14 of the serving platter 10 so that the serving platter 10 may be transported to the dining area, which may be a table in a restaurant, a consumer's own kitchen at home, or any other location at which food may be consumed. Because at least a portion of the receptacle platter 10 is preferably translucent or transparent, a server or customer—as the case may be—will be able to see the food items carried on the serving platter 10 during transport. This may be particularly advantageous in the food service industry for the situation wherein users are take-out customers. The customer will be able to view his order to make sure that it is accurate without having to remove the lid 12 and expose the serving area 16.

At the dining area, the serving platter 10 may be prepared for use simply by removing the lid 12 from the main body 14 by a waitperson, a diner, or the like. Then, as a piece of food is eaten, any food waste created by the food item, e.g., chicken wing bones, may be discarded by dropping the waste through the disposal opening for receipt into the substantially enclosed interior space 24.

In the chicken wing example, this allows a user to eat chicken wings located on the serving platter 10 and easily and neatly discard the bones through the disposal opening of the serving platter 10. The bones are collected in the substantially enclosed interior space 24 of the serving platter 10. As such, the bones are neatly contained within the serving platter 10 while the chicken wings are being eaten. When a user has finished eating the chicken wings, he is left with an eating area free of unsightly, messy bones. Further, the bones may be easily removed from the area by removing the entire serving platter 10.

The bones may be disposed of in a waste receptacle by simply throwing the serving platter 10 away. In this scenario, the serving platter 10 is made from an inexpensive plastic similar to other disposable food containers. Indeed, if the serving platter 10 itself is to be disposable and, thus, intended only for single use, then the serving platter 10 may be fabricated from a variety of thermoplastic materials. Examples include polypropylene, polystyrene and polyethylene terephthatate (PET). They are preferably fabricated of vacuum formed polypropylene. Vacuum forming lends itself to forming relatively flexible components, and the components are well suited to being disposed of after a single use or limited number of uses. Alternatively, the serving platter 10 may be manufactured in a pulp molding process or in some other inexpensive manufacturing process. Pulp molding products are well known and include audio speaker cones and egg cartons. Pulp molding further enables low cost, three-dimensional branding as a result of the ability to selectively raise portions of the surface during the pulp molding.

A disposable serving platter 10 may be preferred for take-out customers of the food service industry. With the serving platter 10 of the present invention, a customer is able to order a food item that is typically served in a restaurant on a serving platter and is able to eat the particular food item as he would eat it in the restaurant, i.e., on a serving platter. In addition, the customer is able to enjoy the benefit of discarding waste into the enclosed interior space of the serving platter 10 and then dispose of the entire serving platter 10 after use.

It is also contemplated that a serving platter 10 may be comprised of a more durable material and therefore may be particularly suitable for repeated use. In a more durable embodiment, the serving platter 10 is preferably relatively more long lasting and rigid and are formed in one or more molding processes. The molding processes may include injection molding, rotational molding, and/or blow molding. In this embodiment, it is further preferred that the serving platter is injection molded polypropylene. Moreover, the upper portion and bottom portion of the main body preferably are removably coupled together, whereby food waste received within the substantially enclosed space readily may be dumped from the bottom portion of the main body and the top and bottom portions may be washed for later re-use. The more durable, rigid serving platter 10, because of the sturdy construction, may be used multiple times with washings between uses. As such, this embodiment may be preferred for commercial food service establishments, such as restaurants, to be used by dine-in customers.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

What is claimed is:

1. A method of making a serving platter comprising the step of molding a hand portable main body such that,
(a) the main body includes,
(i) a top portion defining a serving area comprising a plurality of primary serving wells for receiving food items therein for presentation to a person for eating, and
(ii) a bottom portion defining a substantially enclosed interior space, the top portion defining a disposal opening configured to receive there through food waste for deposit into the substantially enclosed interior space;
(b) wherein the top portion includes a plurality of dividing walls defining and separating the primary serving wells; and
(c) wherein the top portion further defines a plurality of secondary serving wells, each secondary serving well being defined by a partitioning wall that extends between adjacent sides of the outer peripheral wall of the main body.

2. The method of claim 1, wherein the top portion and the bottom portion are part of a single molded piece.

3. The method of claim 1, wherein each of the primary serving wells shares in common a dividing wall with another primary serving well.

4. The method of claim 1, wherein each secondary serving well includes a volume that is less than half of the volume of each primary serving well.

5. The method of claim 1, wherein the disposal opening comprises a circular opening centrally located relative to the serving area.

6. The method of claim 5, wherein each dividing wall extends generally linearly away from the circular opening.

7. The method of claim 5, wherein each dividing wall extends from the circular opening to the outer peripheral wall of the main body.

8. The method of claim 1, wherein the main body is generally rectangular.

9. The method of claim 1, wherein the serving platter consists of four primary serving wells.

10. The method of claim 1, wherein the serving platter consists of four equally dimensioned primary serving wells symmetrically arranged about the disposal opening of the serving area.

11. The method of claim 1, wherein each primary serving well has a bottom defining a food support surface, and wherein the food support surface is planar and configured to be generally horizontal when the serving platter is placed on a generally horizontal surface.

12. The method of claim 1, further comprising molding a shallow lid, the lid being configured to be removably coupled to the main body such that the lid is positioned above and extends over the serving area during transport of the serving platter, the lid defining a plurality of dividers, wherein each of the dividing walls is generally aligned with and engaged by a respective divider such that two wells are isolated from one another by a dividing wall engaged with a divider, and wherein each of the partitioning walls is generally aligned with and engaged by a respective divider such that a primary serving well and a secondary serving well are isolated from one another by a partitioning wall engaged with a divider.

13. The method of claim 1, wherein a dividing wall is engaged by a divider by being received within a channel that is defined by the lid.

14. A method of making a serving platter comprising the step of molding a hand portable main body such that,
(a) the main body is generally rectangular, single molded piece and includes,
(i) a top portion defining a serving area comprising a plurality of primary serving wells for receiving food items therein for presentation to a person for eating, and
(ii) a bottom portion defining a substantially enclosed interior space, the top portion defining a rounded opening centrally located relative to the serving area and configured to receive there through food waste for deposit into the substantially enclosed interior space;
(b) wherein the top portion includes a plurality of dividing walls defining and separating the primary serving wells, each dividing wall extends generally linearly away from the rounded opening to an outer peripheral wall of the main body, each of the primary serving wells sharing in common a dividing wall with another primary serving well; and
(c) wherein the top portion further defines a plurality of secondary serving wells, each secondary serving well being defined by a partitioning wall that extends between adjacent sides of the outer peripheral wall of the main body, each secondary serving well having a volume that is less than half of the volume of each primary serving well.

15. The method of claim 14, further comprising molding a shallow lid that is configured to be removably coupled to the main body such that the lid is positioned above and extends over the serving area and seats off the central opening of the top portion.

16. The method of claim 15, wherein the lid defines a plurality of dividers, each of the dividing walls being generally aligned with and engaged by a respective divider such that two wells are seated off from one another by a dividing wall engaged with a divider.

17. The method of claim 16, wherein each of the partitioning walls also is generally aligned with and engaged by a respective divider such that a primary serving well and a secondary serving well are isolated from one another by a partitioning wall engaged with a divider.

18. A method of making a serving platter comprising the step of molding a hand portable main body such that,
(a) the main body is generally rectangular and includes,
(i) a top portion defining a serving area comprising,
(A) four primary serving wells for receiving food items therein for presentation to a person for eating, and
(B) four secondary serving wells, and
(ii) a bottom portion defining a substantially enclosed interior space, the top portion defining a rounded opening centrally located relative to the serving area and configured to receive there through food waste for deposit into the substantially enclosed interior space;
(b) wherein the top portion includes four dividing walls defining and separating the four primary serving wells, each dividing wall extending generally linearly away from the rounded opening to an outer peripheral wall of the main body, each of the four primary serving wells sharing in common a dividing wall with another of the four primary serving wells; and
(c) wherein the top portion further includes four partitioning walls, each partitioning wall extending between adjacent sides of the outer peripheral wall of the main body, each serving well having a volume that is less than half of the volume of each primary serving well.

19. The method of claim 18, further comprising molding a shallow lid such that the lid is configured to be removably coupled to the main body such that the lid is positioned above and extends over the serving area and seats off the central opening of the top portion.

20. The method of claim 19, wherein the lid defines a plurality of dividers, each of the dividing walls being generally aligned with and engaged by a respective divider such that two wells are seated off from one another by a dividing wall engaged with a divider; and wherein each of the partitioning walls also is generally aligned with and engaged by a respective divider such that a primary serving well and a secondary serving well are isolated from one another by a partitioning wall engaged with a divider.
